(19) United States
(12) Patent Application Publication
(10) Pub. No.: US 2026/0271045 A1
(43) Pub. Date: Sep. 10, 2026

(54) METHOD AND APPARATUS OF DETERMINING SENSING BEAM SIZE FOR AI/ML-BASED BEAM MANAGEMENT IN MOBILE COMMUNICATIONS

(71) Applicant: MEDIATEK INC., Hsinchu City (TW)

(72) Inventors: Yu-Jen KU, San Jose, CA (US); Wan-Chi LEE, Hsinchu City (TW); Gyu Bum KYUNG, San Jose, CA (US)

(21) Appl. No.: 19/165,982

(22) PCT Filed: May 15, 2024
(86) PCT No.: PCT/CN2024/093381

§ 371 Date: Sep. 16, 2025

Related U.S. Application Data
(60) Provisional application No. 63/502,132, filed on May 15, 2023.

(51) Int. Cl. H04W 72/542; H04L 41/16; H04W 72/231; H04W 72/51

(52) U.S. Cl. CPC H04W 72/542; H04L 41/16; H04W 72/231; H04W 72/51

(57) ABSTRACT

Examples pertaining to determining sensing beam size for artificial intelligence (AI)/machine learning (ML)-based beam management in mobile communications are described. An apparatus determines a throughput or location of a user equipment (UE). Based on the throughput or location of the UE, the apparatus adjusts a size of a set of reference signal (RS) resources configured for the UE to measure as an input to an artificial intelligence (AI)/machine learning (ML) model.

### CROSS REFERENCE TO RELATED PATENT APPLICATION(S)

The present disclosure is part of a non-provisional application claiming the priority benefit of U.S. Patent Application No. 63/502,132, filed 15 May 2023, the content of which herein being incorporated by reference in its entirety.

### TECHNICAL FIELD

The present disclosure is generally related to mobile communications and, more particularly, to determining sensing beam size for artificial intelligence (AI)/machine learning (ML)-based beam management in mobile communications.

### BACKGROUND

Unless otherwise indicated herein, approaches described in this section are not prior art to the claims listed below and are not admitted as prior art by inclusion in this section.

In wireless communications such as mobile communications under the 3^{rd} Generation Partnership Project (3GPP) standards, a user equipment (UE) and a base station (e.g., gNB) need to find a best beam to communicate with each other, yet exhaustive beam sweeping overhead could be significantly increased as the number of available beams increases. Accordingly, beamforming is a technique that can increase downlink (DL) throughput and, thus, is essential for the millimeter wave (mmWave) technology in future wireless systems. Compared with the existing exhaustive beam sweeping procedure, an AI/ML-based solution can provide a faster way to obtain information of the best beam. For instance, an AI/ML-based beam management can reduce the required number and time of layer 1 reference signal received power (L1-RSRP) measurement.

In mobile communications under the 3GPP standards, the concept of “spatial beam prediction” refers to the inference of the optimal communication beams using power measurement of the sensing beams. The number of sensing beams is less than the number of communication beams. During operation with respect to spatial beam prediction, network 120 and/or UE 110 measures the receive power of all the beams in the sensing beam codebook. Then, network 120 and/or UE 110 infers the optimal communication beams from the sensing beam reference signal received power (RSRP). Moreover, the concept of “temporal beam prediction” refers to the prediction of the future optimal beam indices using the beam measurements on the sensing beams of the previous time steps. The RSRP of one or more beams can be predicted with an input of history of RSRPs. In 3GPP discussions, the set of beams that is being measured as AI/ML input (sensing beams) is referred to as “Set B” of beams. The set of beams that is being predicted as AI/ML output (usually communication beams) is referred to as “Set A” of beams.

In general, the size of Set B controls the beam prediction accuracy and beam measurement overhead performances of AI/ML-based beam management. For example, in spatial beam prediction with measurement of a number of 4, 8 or 16 of Set B of beams (which are sensing beams) to predict the best beam(s) among 32 communication beams (i.e., Set A of beams), performances of measuring a Set B size of 16 for AI/ML model input tends to be always higher than a Set B size of 8. Similarly, performances of measuring a Set B size of 8 tends to be always higher than a Set B size of 4. As can be seen, a larger size of Set B tends to result in a higher beam prediction accuracy (e.g., due to more input information for the AI/ML model) but with a higher beam measurement overhead (e.g., due to more beams for the UE to measure). Conversely, a smaller size of Set B tends to result in a lower beam prediction accuracy (e.g., due to less input information for the AI/ML model) but with a lower beam measurement overhead (e.g., due to fewer beams for the UE to measure). However, currently there is no mechanism for the UE to dynamically determine the size of Set B. Therefore, there is a need for a solution of determining sensing beam size for AI/ML-based beam management in mobile communications.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to determining sensing beam size for AI/ML-based beam management in mobile communications. It is believed that implementation of one or more schemes proposed herein may avoid or otherwise alleviate issue(s) described herein.

In one aspect, a method may involve determining a throughput of a UE. The method may also involve adjusting a size of a set of reference signal (RS) resources configured for the UE to measure as an input to an AI/ML model based on the throughput of the UE.

In another aspect, a method may involve determining a location of a UE. The method may also involve adjusting a size of a set of RS resources configured for the UE to measure as an input to an AI/ML model based on the location of the UE.

In yet another aspect, an apparatus implementable in a UE may include a transceiver configured to communicate wirelessly and a processor coupled to the transceiver. The processor may determine a throughput or location of a UE. The processor may also adjust a size of a set of RS resources configured for the UE to measure as an input to an AI/ML model based on the throughput or location of the UE.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), Industrial Internet of Things (IIoT), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario of a beam management procedure in accordance with implementations of the present disclosure.

FIG. 2 is a diagram depicting an example scenario under a proposed scheme in accordance with the present disclosure.

FIG. 3 is a diagram depicting an example scenario under a proposed scheme in accordance with the present disclosure.

FIG. 4 is a diagram depicting an example scenario under a proposed scheme in accordance with the present disclosure.

FIG. 5 is a diagram depicting an example scenario under a proposed scheme in accordance with the present disclosure.

FIG. 6 is a diagram depicting an example scenario under a proposed scheme in accordance with the present disclosure.

FIG. 7 is a diagram depicting an example communication system having an example communication apparatus and an example network apparatus in accordance with an implementation of the present disclosure.

FIG. 8 is a diagram depicting an example process in accordance with an implementation of the present disclosure.

FIG. 9 is a diagram depicting an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to determining sensing beam size for AI/ML-based beam management in mobile communications. According to the present disclosure, a number of possible solutions may be implemented separately or jointly. That is, although these possible solutions may be described below separately, two or more of these possible solutions may be implemented in one combination or another.

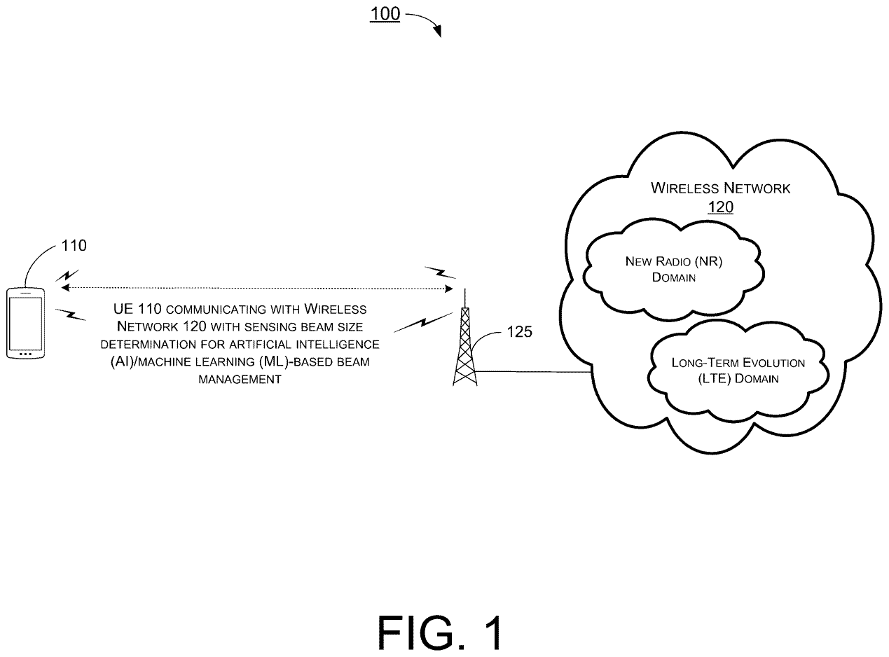

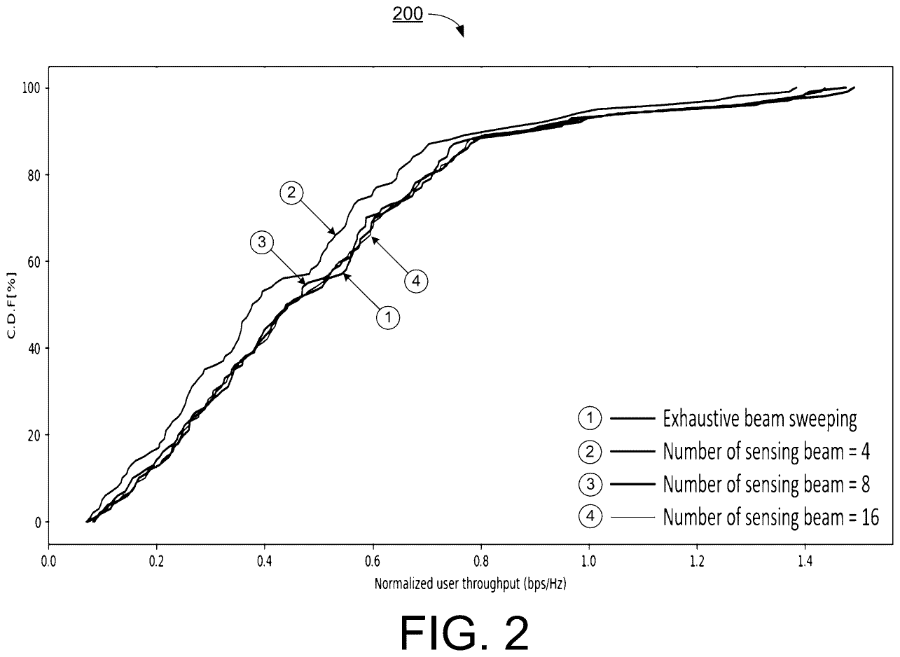

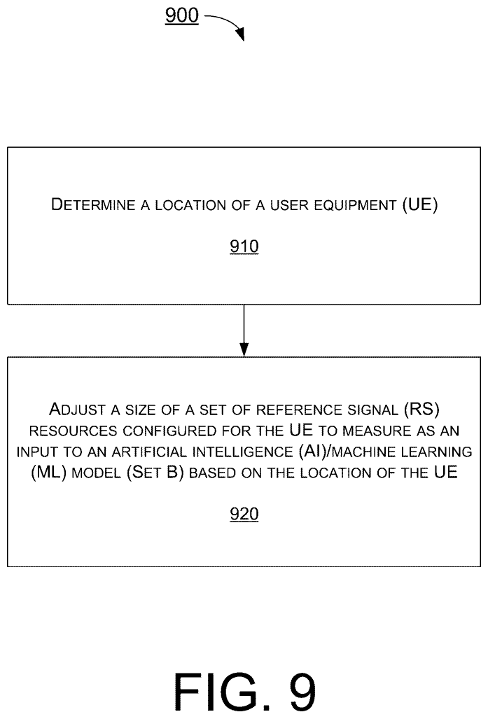

FIG. 1 illustrates an example network environment 100 in which various solutions and schemes in accordance with the present disclosure may be implemented. FIG. 2~FIG. 9 illustrate examples of implementation of various proposed schemes in network environment 100 in accordance with the present disclosure. The following description of various proposed schemes is provided with reference to FIG. 1~FIG. 9.

Referring to FIG. 1, network environment 100 may involve a UE 110, such as a mobile device or smartphone, in wireless communication with a wireless network 120 as part of a communication network. The wireless network 120 may be a public land mobile network (PLMN) including 5G/NR domain and LTE domain. UE 110 may be in, or attempting to establish, wireless communication with wireless network 120 via a base station or network node 125 (e.g., an eNB, gNB or transmit-receive point (TRP)). In network environment 100, UE 110 and wireless network 120 via network node 125 may implement various schemes pertaining to enhancement of determining sensing beam size for AI/ML-based beam management in mobile communications, as described herein. It is noteworthy that, while the various proposed schemes may be individually or separately described below, in actual implementations some or all of the proposed schemes may be utilized or otherwise implemented jointly. Of course, each of the proposed schemes may be utilized or otherwise implemented individually or separately.

FIG. 2 illustrates an example scenario 200 of a simulation of a cumulative distribution function of UE throughput, in which UEs are dropped in different locations. After the normalized user throughput is higher than 0.8, the performance of using four sensing beams is almost the same as using 16 sensing beams and close to exhaustive beam sweeping. As such, there is no need of using a higher number of sensing beams when the UE throughput is high. Moreover, a lower throughput usually indicates that a UE is at the end of a cell. Throughput distribution analysis like the one shown in FIG. 2 allows determination of the size of Set B (or the number of sensing beams, wherein these beams are for UE to measure as an input to an AI/ML model) based on a UE's throughput or the UE's location.

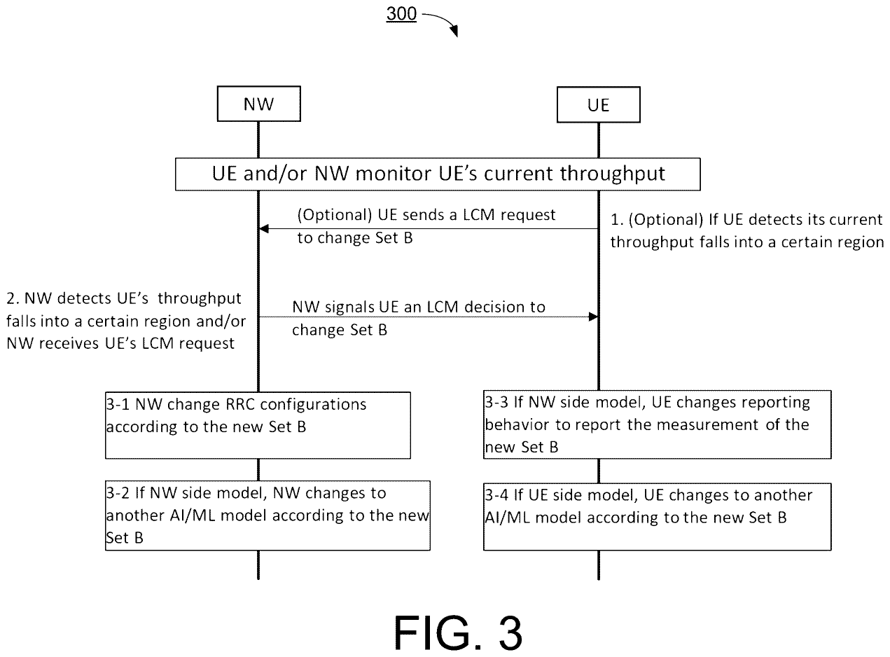

FIG. 3 illustrates an example scenario 300 under a proposed scheme in accordance with the present disclosure. Scenario 300 may pertain to determination of the size of Set B based on a UE's throughput. Referring to FIG. 3, network 120 and/or UE 110 may keep monitoring the current throughput (e.g., downlink throughput) of UE 110. Optionally, in case UE 110 detects that its current throughput falls into a certain level, UE 110 may send a request to network 120 for a change in life cycle management (LCM) of Set B to a new Set B. Once the current throughput of UE 110 falls into a certain level, network 120 may signal UE 110 an LCM decision to change Set B. UE 110 or network 120 may change its AI/ML model and/or reporting configuration and behavior according to the new Set B. For instance, network 120 may change radio resource control (RRC) configurations according to the new Set B. Moreover, in case of a network-side AI/ML model, network 120 may change to another AI/ML model according to the new Set B. Moreover, in case of a network-side AI/ML model, UE 110 may change its signal measuring and reporting behavior to report a measurement of the new Set B. Alternatively, in case of a UE-side AI/ML model, UE 110 may change to another AI/ML model and signal measuring behavior according to the new Set B.

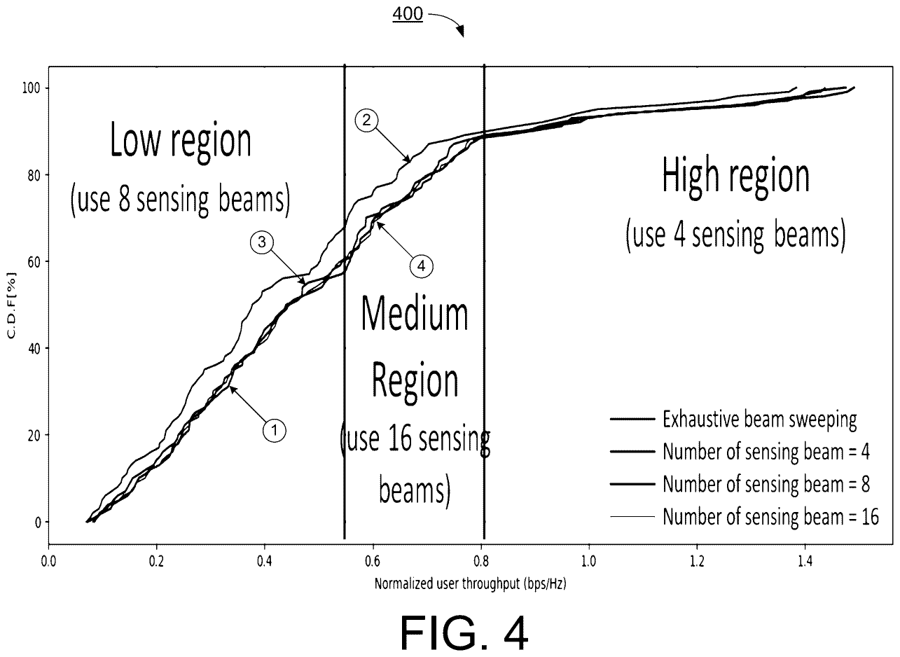

FIG. 4 illustrates an example scenario 400 under the proposed scheme with respect to determination of the size of Set B based on a UE's throughput. Referring to FIG. 4, normalized throughputs may be separated into three regions of high, medium and low throughput. In an event that the throughput of UE 110 is in the high region, UE 110 may apply four Set B of beams. In an event that the throughput of UE 110 is in the medium region, UE 110 may apply sixteen Set B of beams. In an event that the throughput of UE 110 is in the low region, UE 110 may apply eight Set B of beams.

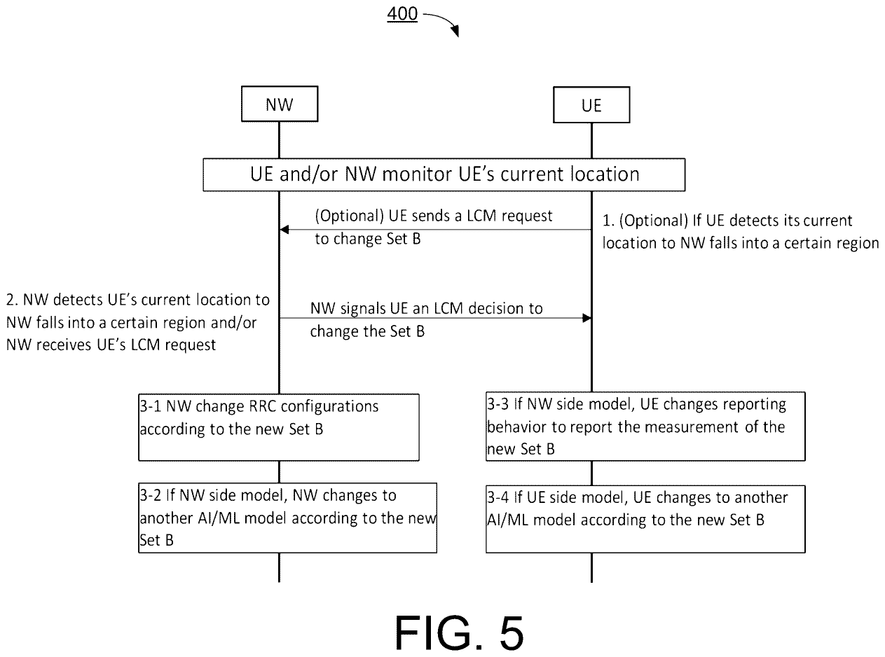

FIG. 5 illustrates an example scenario 500 under a proposed scheme in accordance with the present disclosure. Scenario 500 may pertain to determination of the size of Set B based on a UE's location. Referring to FIG. 5, network 120 and/or UE 110 may keep monitoring the current throughput of UE 110. Optionally, in case UE 110 detects that its distance to network 120 falls into a certain level, UE 110 may send a request to network 120 for a change in LCM of Set B. Once the current distance of UE 110 to network 120 falls into a certain level, network 120 may signal UE 110 an LCNM decision to change Set B. UE 110 or network 120 may change its AI/ML model and/or reporting configuration and behavior according to the new Set B. For instance, network 120 may change RRC configurations according to the new Set B. Moreover, in case of a network-side AI/ML model, network 120 may change to another AI/ML model according to the new Set B. Moreover, in case of a network-side AI/ML model, UE 110 may change its reporting behavior to report a measurement of the new Set B. Alternatively, in case of a UE-side AI/ML model, UE 110 may change to another AI/ML model according to the new Set B.

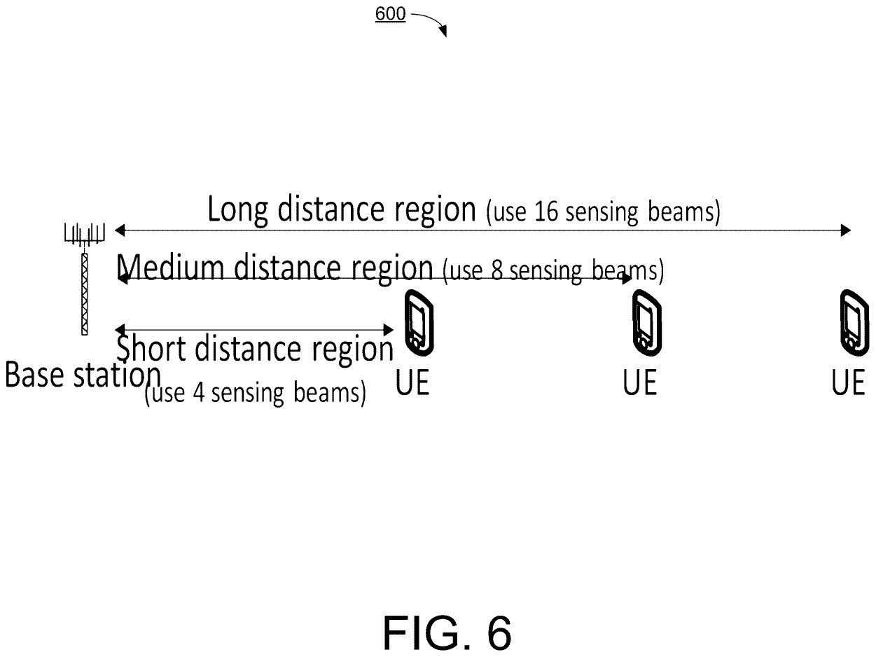

FIG. 6 illustrates an example scenario 600 under the proposed scheme with respect to determination of the size of Set B based on a UE's location. Referring to FIG. 6, the UE's location in a serving cell coverage area may be separated into three regions of long, medium and short distance. In an event that the location of UE 110 is at the serving cell's edge (e.g., UE-network distance>150 meters), UE 110 may apply sixteen Set B of beams. In an event that the location of UE 110 is in a medium distance region with respect to the serving cell (e.g., UE-network distance<150 meters and >80 meters), UE 110 may apply eight Set B of beams. In an event that the location of UE 110 is in a center region of serving cell (e.g., UE-network distance<80 meters), UE 110 may apply four Set B of beams.

In view of the above, certain aspects of the proposed schemes with respect to a UE-side model may be summarized below.

In one aspect, a procedure to determine Set B (e.g., a set of reference signal (RS) resources configured for a UE to measure as an input to an AI/ML model) may be based on the UE's throughput. The UE's throughput may be separated into different throughput regions, and a respective (different) Set Bs may be applied to each throughput region. Either or both of the network and the UE may monitor the UE's current throughput. In case that the UE detects that its current throughput falls into a certain level, the UE may send a request to the network for a change of Set B. Once the UE's current throughput falls into a certain level, the network may initiate an LCM decision to change Set B to a new Set B. The UE or the network may change its AI/ML model and/or reporting configuration and behavior according to the new Set B.

In another aspect, a procedure to determine Set B (e.g., the set of RS resources configured for a UE to measure as an input to an AI/ML model) may be based on the UE's location. The UE's location may be separated into different distance regions, and a respective (different) Set Bs may be applied to each distance region. Either or both of the network and the UE may monitor the UE's current location. In case that the UE detects that its current distance to the network (e.g., serving cell) falls into a certain level, the UE may send a request to the network for a change of Set B. Once the UE's current distance to the network falls into a certain level, the network may signal the UE an LCM decision to change Set B to a new Set B. The UE or the network may change its AI/ML model and/or reporting configuration and behavior according to the new Set B.

### Illustrative Implementations

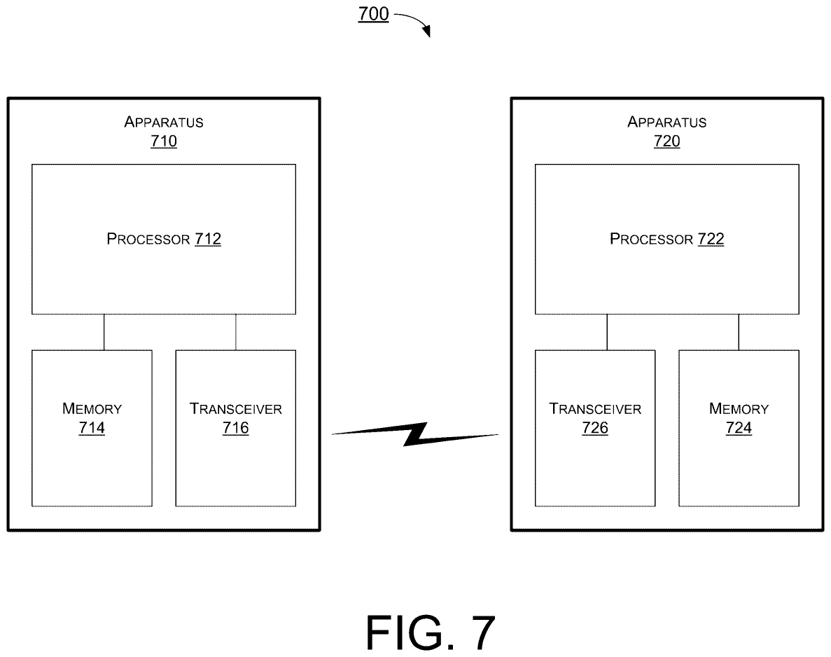

FIG. 7 illustrates an example communication system 700 having at least an example apparatus 710 and an example apparatus 720 in accordance with an implementation of the present disclosure. Each of apparatus 710 and apparatus 720 may perform various functions to implement schemes, techniques, processes and methods described herein pertaining to determining Set B size for AI/ML-based beam management in mobile communications, including the various schemes described above with respect to various proposed designs, concepts, schemes, systems and methods described above, including network environment 100, as well as processes described below.

Each of apparatus 710 and apparatus 720 may be a part of an electronic apparatus, which may be a network apparatus or a UE (e.g., UE 110), such as a portable or mobile apparatus, a wearable apparatus, a vehicular device or a vehicle, a wireless communication apparatus or a computing apparatus. For instance, each of apparatus 710 and apparatus 720 may be implemented in a smartphone, a smart watch, a personal digital assistant, an electronic control unit (ECU) in a vehicle, a digital camera, or a computing equipment such as a tablet computer, a laptop computer or a notebook computer. Each of apparatus 710 and apparatus 720 may also be a part of a machine type apparatus, which may be an IoT apparatus such as an immobile or a stationary apparatus, a home apparatus, a roadside unit (RSU), a wire communication apparatus or a computing apparatus. For instance, each of apparatus 710 and apparatus 720 may be implemented in a smart thermostat, a smart fridge, a smart door lock, a wireless speaker or a home control center. When implemented in or as a network apparatus, apparatus 710 and/or apparatus 720 may be implemented in an eNodeB in an LTE, LTE-Advanced or LTE-Advanced Pro network or in a gNB or TRP in a 5G network, an NR network, or an IoT network.

In some implementations, each of apparatus 710 and apparatus 720 may be implemented in the form of one or more integrated-circuit (IC) chips such as, for example and without limitation, one or more single-core processors, one or more multi-core processors, one or more complex-instruction-set-computing (CISC) processors, or one or more reduced-instruction-set-computing (RISC) processors. In the various schemes described above, each of apparatus 710 and apparatus 720 may be implemented in or as a network apparatus or a UE. Each of apparatus 710 and apparatus 720 may include at least some of those components shown in FIG. 7 such as a processor 712 and a processor 722, respectively, for example. Each of apparatus 710 and apparatus 720 may further include one or more other components not pertinent to the proposed scheme of the present disclosure (e.g., internal power supply, display device and/or user interface device), and, thus, such component(s) of apparatus 710 and apparatus 720 are neither shown in FIG. 7 nor described below in the interest of simplicity and brevity.

In one aspect, each of processor 712 and processor 722 may be implemented in the form of one or more single-core processors, one or more multi-core processors, or one or more CISC or RISC processors. That is, even though a singular term “a processor” is used herein to refer to processor 712 and processor 722, each of processor 712 and processor 722 may include multiple processors in some implementations and a single processor in other implementations in accordance with the present disclosure. In another aspect, each of processor 712 and processor 722 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 712 and processor 722 is a special-purpose machine specifically designed, arranged, and configured to perform specific tasks including those pertaining to UE behavior for determining sensing beam size for AI/ML-based beam management in mobile communications in accordance with various implementations of the present disclosure.

In some implementations, apparatus 710 may also include a transceiver 716 coupled to processor 712. Transceiver 716 may be capable of wirelessly transmitting and receiving data. In some implementations, transceiver 716 may be capable of wirelessly communicating with different types of wireless networks of different radio access technologies (RATs). In some implementations, transceiver 716 may be equipped with a plurality of antenna ports (not shown) such as, for example, four antenna ports. That is, transceiver 716 may be equipped with multiple transmit antennas and multiple receive antennas for multiple-input multiple-output (MIMO) wireless communications. In some implementations, apparatus 720 may also include a transceiver 726 coupled to processor 722. Transceiver 726 may include a transceiver capable of wirelessly transmitting and receiving data. In some implementations, transceiver 726 may be capable of wirelessly communicating with different types of UEs/wireless networks of different RATs. In some implementations, transceiver 726 may be equipped with a plurality of antenna ports (not shown) such as, for example, four antenna ports. That is, transceiver 726 may be equipped with multiple transmit antennas and multiple receive antennas for MIMO wireless communications.

In some implementations, apparatus 710 may further include a memory 714 coupled to processor 712 and capable of being accessed by processor 712 and storing data therein. In some implementations, apparatus 720 may further include a memory 724 coupled to processor 722 and capable of being accessed by processor 722 and storing data therein. Each of memory 714 and memory 724 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 714 and memory 724 may include a type of read-only memory (ROM) such as mask ROM, programmable ROM (PROM), erasable programmable ROM (EPROM) and/or electrically erasable programmable ROM (EEPROM). Alternatively, or additionally, each of memory 714 and memory 724 may include a type of non-volatile random-access memory (NVRAM) such as flash memory, solid-state memory, ferroelectric RAM (FeRAM), magnetoresistive RAM (MRAM) and/or phase-change memory.

Each of apparatus 710 and apparatus 720 may be a communication entity capable of communicating with each other using various proposed schemes in accordance with the present disclosure. For illustrative purposes and without limitation, a description of capabilities of apparatus 710, as a UE (e.g., UE 110), and apparatus 720, as a network node (e.g., network node 125) of a network (e.g., wireless network 120 as a 5G/NR mobile network), is provided below in the context of example processes 800 and 900.

### Illustrative Processes

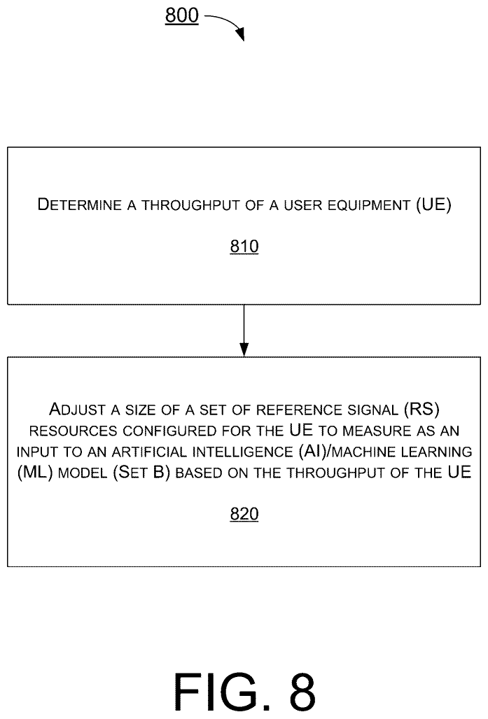

FIG. 8 illustrates an example process 800 in accordance with an implementation of the present disclosure. Process 800 may represent an aspect of implementing various proposed designs, concepts, schemes, systems and methods described above. More specifically, process 800 may represent an aspect of the proposed concepts and schemes pertaining to determining sensing beam size for AI/ML-based beam management in mobile communications in accordance with the present disclosure. Process 800 may include one or more operations, actions, or functions as illustrated by one or more of blocks 810 and 820. Although illustrated as discrete blocks, various blocks of process 800 may be divided into additional blocks, combined into fewer blocks, or eliminated, depending on the desired implementation. Moreover, the blocks/sub-blocks of process 800 may be executed in the order shown in FIG. 8 or, alternatively, in a different order. Furthermore, one or more of the blocks/sub-blocks of process 800 may be executed repeatedly or iteratively. Process 800 may be implemented by or in apparatus 710 and apparatus 720 as well as any variations thereof. Solely for illustrative purposes and without limiting the scope, process 800 is described below in the context of apparatus 710 as a UE (e.g., UE 110) and apparatus 720 as a communication entity such as a network node or base station (e.g., network node 125) of a network (e.g., wireless network 120). Process 800 may begin at block 810.

At 810, process 800 may involve processor 712 of apparatus 710 and/or processor 722 of apparatus 720 determining a throughput of a UE (e.g., apparatus 710 as UE 110). Process 800 may proceed from 810 to 820.

At 820, process 800 may involve processor 712 or processor 722 adjusting a size of a set of RS resources configured for the UE to measure as an input to an AI/ML model (Set B) based on the throughput of the UE.

In some implementations, in determining, process 800 may involve processor 712 performing certain operations. For instance, process 800 may involve processor 712 monitoring a current throughput of the UE. Additionally, process 800 may involve processor 712 detecting that the current throughput falls into a predefined level. Moreover, process 800 may involve processor 712 sending a request to a network for an LCM change of the size of the Set B responsive to the detecting. In some implementations, in adjusting, process 800 may involve processor 712 performing certain operations. For instance, process 800 may involve processor 712 receiving, from the network (e.g., wireless network 120 via apparatus 720 as network node 125), a signal of an LCM decision to change the Set B to a new Set B. Moreover, process 800 may involve processor 712 changing, according to the new Set B, at least one of: (a) the AI/ML model and signal measurement behavior according to the new Set B, and (b) a reporting behavior to report a measurement of the new Set B.

In some implementations, in determining, process 800 may involve processor 722 performing certain operations. For instance, process 800 may involve processor 722 monitoring a current throughput of the UE. Additionally, process 800 may involve processor 722 detecting that the current throughput falls into a predefined level. Moreover, process 800 may involve processor 722 signaling to the UE an LCM decision to change the Set B to a new Set B responsive to the detecting. In some implementations, in adjusting, process 800 may involve processor 722 performing certain operations. For instance, process 800 may involve processor 722 changing, according to the new Set B, at least one of: (a) the AI/ML model according to the new Set B, and (b) an RRC configuration according to the new Set B.

In some implementations, the size of the set of RS resources may include a size of a set of beams that UE measures for inference by the AI/ML model.

FIG. 9 illustrates an example process 900 in accordance with an implementation of the present disclosure. Process 900 may represent an aspect of implementing various proposed designs, concepts, schemes, systems and methods described above. More specifically, process 900 may represent an aspect of the proposed concepts and schemes pertaining to determining sensing beam size for AI/ML-based beam management in mobile communications in accordance with the present disclosure. Process 900 may include one or more operations, actions, or functions as illustrated by one or more of blocks 910 and 920. Although illustrated as discrete blocks, various blocks of process 900 may be divided into additional blocks, combined into fewer blocks, or eliminated, depending on the desired implementation. Moreover, the blocks/sub-blocks of process 900 may be executed in the order shown in FIG. 9 or, alternatively, in a different order. Furthermore, one or more of the blocks/sub-blocks of process 900 may be executed repeatedly or iteratively. Process 900 may be implemented by or in apparatus 710 and apparatus 720 as well as any variations thereof. Solely for illustrative purposes and without limiting the scope, process 900 is described below in the context of apparatus 710 as a UE (e.g., UE 110) and apparatus 720 as a communication entity such as a network node or base station (e.g., network node 125) of a network (e.g., wireless network 120). Process 900 may begin at block 910.

At 910, process 900 may involve processor 712 of apparatus 710 and/or processor 722 of apparatus 720 determining a location of a UE (e.g., apparatus 710 as UE 110). Process 900 may proceed from 910 to 920.

At 920, process 900 may involve processor 712 or processor 722 adjusting a size of a set of RS resources configured for the UE to measure as an input to an AI/MWL model (Set B) based on the location of the UE.

In some implementations, in determining, process 900 may involve processor 712 performing certain operations. For instance, process 900 may involve processor 712 monitoring a current distance between the UE and a serving cell (e.g., apparatus 720 as network node 125) of a network (e.g., wireless network 120). Additionally, process 900 may involve processor 712 detecting that the current distance falls into a predefined level. Moreover, process 900 may involve processor 712 sending a request to the network for an LCM change of the size of the Set B responsive to the detecting. In some implementations, in adjusting, process 900 may involve processor 712 performing certain operations. For instance, process 900 may involve processor 712 receiving, from the network, a signal of an LCM decision to change the Set B to a new Set B. Moreover, process 900 may involve processor 712 changing, according to the new Set B, at least one of: (a) the AI/ML model and signal measurement behavior according to the new Set B, and (b) a reporting behavior to report a measurement of the new Set B.

In some implementations, in determining, process 900 may involve processor 722 performing certain operations. For instance, process 900 may involve processor 722 monitoring a current distance between the UE and a serving cell of the network. Additionally, process 900 may involve processor 722 detecting that the current throughput falls into a predefined level. Moreover, process 900 may involve processor 722 signaling to the UE an LCM decision to change the Set B to a new Set B responsive to the detecting. In some implementations, in adjusting, process 900 may involve processor 722 performing certain operations. For instance, process 900 may involve processor 722 changing, according to the new Set B, at least one of: (a) the AI/ML model according to the new Set B, and (b) an RRC configuration according to the new Set B.

In some implementations, the size of the set of RS resources may include a size of a set of beams that UE measures for inference by the AI/ML model.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
determining a throughput of a user equipment (UE); and
adjusting a size of a set of reference signal (RS) resources configured for the UE to measure as an input to an artificial intelligence (AI)/machine learning (ML) model (Set B) based on the throughput of the UE.

2. The method of claim 1, wherein the determining comprises the UE performing operations comprising:
monitoring a current throughput of the UE;
detecting that the current throughput falls into a predefined level; and
sending a request to a network for a life cycle management (LCM) change of the size of the Set B responsive to the detecting.

3. The method of claim 2, wherein the adjusting comprises the UE performing operations comprising:
receiving, from the network, a signal of an LCM decision to change the Set B to a new Set B; and
changing, according to the new Set B, at least one of:
the AI/ML model and signal measurement behavior according to the new Set B, and
a reporting behavior to report a measurement of the new Set B.

4. The method of claim 1, wherein the determining comprises a network performing operations comprising:
monitoring a current throughput of the UE;
detecting that the current throughput falls into a predefined level; and
signaling to the UE a life cycle management (LCM) decision to change the Set B to a new Set B responsive to the detecting.

5. The method of claim 4, wherein the adjusting comprises the network performing operations comprising:
changing, according to the new Set B, at least one of:
the AI/ML model according to the new Set B, and
a radio resource control (RRC) configuration according to the new Set B.

6. The method of claim 1, wherein the size of the set of RS resources comprises a size of a set of beams that UE measures for inference by the AI/ML model.

7. A method, comprising:
determining a location of a user equipment (UE); and
adjusting a size of a set of reference signal (RS) resources configured for the UE to measure as an input to an artificial intelligence (AI)/machine learning (ML) model (Set B) based on the location of the UE.

8. The method of claim 7, wherein the determining comprises the UE performing operations comprising:
monitoring a current distance between the UE and a serving cell of a network;
detecting that the current distance falls into a predefined level; and
sending a request to the network for a life cycle management (LCM) change of the size of the Set B responsive to the detecting.

9. The method of claim 8, wherein the adjusting comprises the UE performing operations comprising:
receiving, from the network, a signal of an LCM decision to change the Set B to a new Set B; and
changing, according to the new Set B, at least one of:
the AI/ML model and signal measurement behavior according to the new Set B, and
a reporting behavior to report a measurement of the new Set B.

10. The method of claim 7, wherein the determining comprises a network performing operations comprising:
monitoring a current distance between the UE and a serving cell of the network;
detecting that the current throughput falls into a predefined level; and
signaling to the UE a life cycle management (LCM) decision to change the Set B to a new Set B responsive to the detecting.

11. The method of claim 10, wherein the adjusting comprises the network performing operations comprising:
changing, according to the new Set B, at least one of:
the AI/ML model according to the new Set B, and
a radio resource control (RRC) configuration according to the new Set B.

12. The method of claim 7, wherein the size of the set of RS resources comprises a size of a set of beams that UE measures for inference by the AI/ML model.

13. An apparatus, comprising:
a transceiver configured to communicate wirelessly; and
a processor coupled to the transceiver and configured to perform operations comprising:
determining a throughput or location of a user equipment (UE); and
adjusting a size of a set of reference signal (RS) resources configured for the UE to measure as an input to an artificial intelligence (AI)/machine learning (ML) model (Set B) based on the throughput or location of the UE.

14. The apparatus of claim 13, wherein, in an event that the apparatus is implemented in the UE, the determining comprises:
monitoring a current throughput of the UE or a current distance between the UE and a serving cell of a network;
detecting that the current throughput or the current distance falls into a predefined level; and
sending a request to the network for a life cycle management (LCM) change of the size of the Set B responsive to the detecting.

15. The apparatus of claim 14, wherein the adjusting comprises:
receiving, from the network, a signal of an LCM decision to change the Set B to a new Set B; and
changing, according to the new Set B, at least one of:
the AI/ML model and signal measurement behavior according to the new Set B, and
a reporting behavior to report a measurement of the new Set B.

16. The apparatus of claim 13, wherein, in an event that the apparatus is implemented in a network, the determining comprises:
monitoring a current throughput of the UE or a current distance between the UE and a serving cell of the network;
detecting that the current throughput or the current distance falls into a predefined level; and
signaling to the UE a life cycle management (LCM) decision to change the Set B to a new Set B responsive to the detecting.

17. The apparatus of claim 16, wherein the adjusting comprises the network performing operations comprising:
changing, according to the new Set B, at least one of:
the AI/ML model according to the new Set B, and
a radio resource control (RRC) configuration according to the new Set B.

18. The apparatus of claim 13, wherein the size of the set of RS resources comprises a size of a set of beams that UE measures for interference by the AI/ML model.
